(19) United States
(12) Patent Application Publication
(10) Pub. No.: US 2004/0237326 A1
(43) Pub. Date: Dec. 2, 2004

(54) Multifunctional measuring tape assembly

(76) Inventor: Chien-Kuo Wang, Taichung (TW)

Correspondence Address: Chien-Kuo Wang, 58, MA YUAN WEST ST., TAICHUNG, TW

(21) Appl. No.: 10/448,091

(22) Filed: May 27, 2003

(51) Int. Cl. G01B 3/10

(52) U.S. Cl. 33/760

(57) ABSTRACT

A measuring tape assembly includes a housing, a first level mounted on the housing, a second level mounted on the housing and having a direction different from that of the first level, and a scrolling tape rotatably mounted in the housing. Thus, measuring tape assembly can be used to adjust and calibrate the level of the article in two directions by the first level and the second level vertical to each other.

### BACKGROUND OF THE INVENTION

1. Field of the Invention

The present invention relates to a measuring tape assembly, and more particularly to a multifunctional measuring tape assembly.

2. Description of the Related Art

A conventional measuring tape only has a single measuring function, and is not provided with an illumination device and a level, so that the conventional measuring tape cannot provide an illumination effect and a level calibration effect to the user. Thus, the user has to additionally carry many auxiliary tools, such as the illumination device, the level or the like, so that he can work in different environments, thereby causing inconvenience to the user.

### SUMMARY OF THE INVENTION

The primary objective of the present invention is to provide a measuring tape assembly that can be used to adjust and calibrate the level of the article in two directions by the first level and the second level vertical to each other.

Another objective of the present invention is to provide a measuring tape assembly, wherein the illumination device produces a light toward the scrolling tape, thereby providing an illumination effect to the user.

A further objective of the present invention is to provide a measuring tape assembly, wherein the laser head can produce a laser light which passes through the spectroscope and is emitted outward from the through hole of the housing, thereby forming a horizontal positioning line via the spectroscope, so as to form a horizontal basis for hitting the nail, thereby facilitating the user's work.

A further objective of the present invention is to provide a measuring tape assembly, wherein the user can quickly search for the joist (or post) by the magnetic body mounted in the oblique hole of the housing.

A further objective of the present invention is to provide a measuring tape assembly, wherein the oblique hole of the housing has an inclined angle, so that the magnetic body mounted in the oblique hole of the housing will slide into the inner side of the oblique hole of the housing when not in use.

In accordance with the present invention, there is provided a measuring tape assembly, comprising:

a housing;

a first level mounted on the housing;

a second level mounted on the housing and having a direction different from that of the first level; and

a scrolling tape rotatably mounted in the housing.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a measuring tape assembly in accordance with the preferred embodiment of the present invention;

FIG. 2 is a partially perspective assembly view of the measuring tape assembly in accordance with the preferred embodiment of the present invention;

FIG. 3 is a perspective assembly view of the measuring tape assembly in accordance with the preferred embodiment of the present invention;

FIG. 4 is a perspective assembly view of the measuring tape assembly in accordance with the preferred embodiment of the present invention;

FIG. 4A is a partially cut-away enlarged view of the measuring tape assembly as shown in FIG. 4;

FIG. 5 is a perspective operational view of the measuring tape assembly in accordance with the preferred embodiment of the present invention;

FIG. 6 is a side plan view of the measuring tape assembly in accordance with the preferred embodiment of the present invention;

FIG. 7 is a schematic operational view of the measuring tape assembly as shown in FIG. 6 in use;

FIG. 8 is a perspective operational view of the measuring tape assembly in accordance with the preferred embodiment of the present invention;

FIG. 9 is a perspective operational view of the measuring tape assembly in accordance with the preferred embodiment of the present invention;

FIG. 10 is a side plan partially cross-sectional view of the measuring tape assembly in accordance with the preferred embodiment of the present invention; and

FIG. 11 is a side plan partially cross-sectional view of the measuring tape assembly in accordance with the preferred embodiment of the present invention.

### DETAILED DESCRIPTION OF THE INVENTION

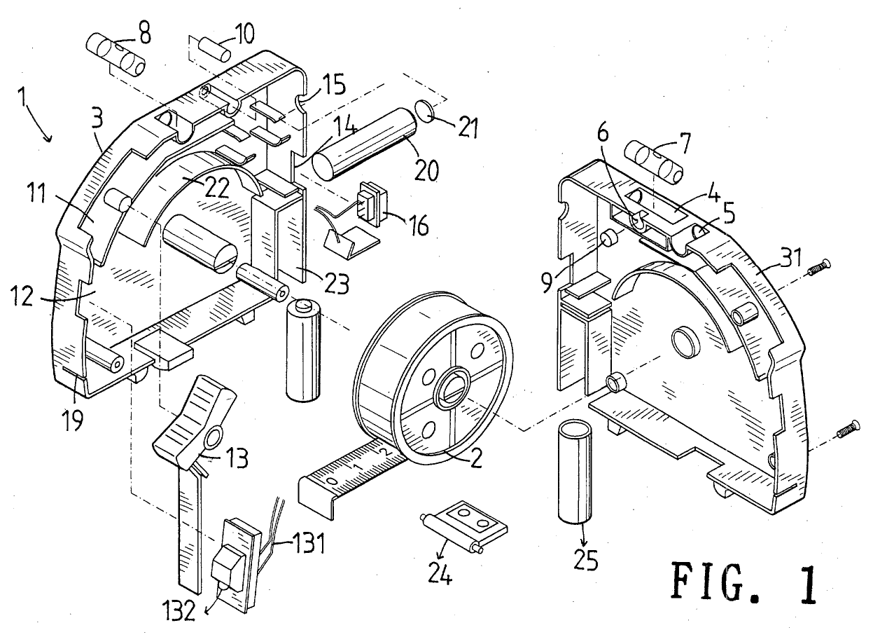

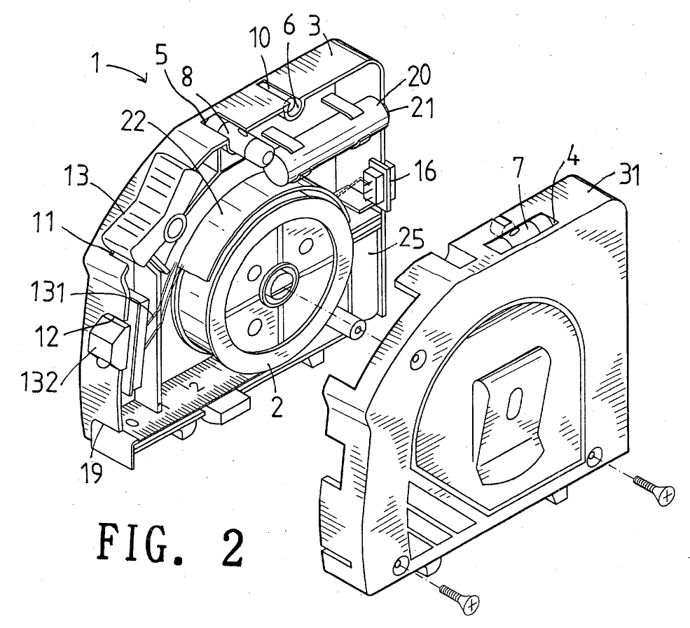

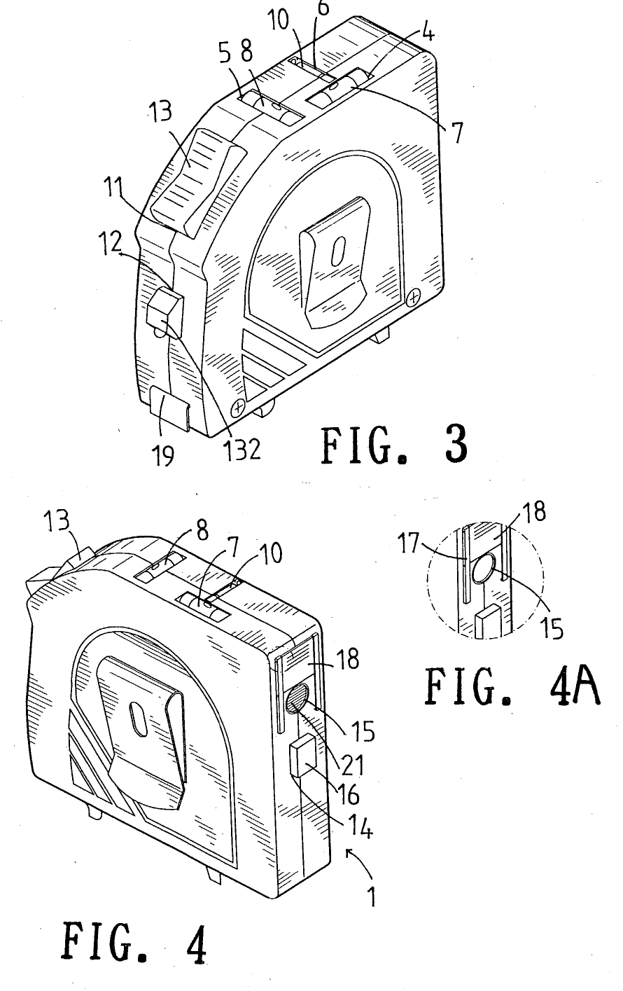

Referring to the drawings and initially to FIGS. 1-4, a measuring tape assembly in accordance with the preferred embodiment of the present invention comprises a housing 1, and a scrolling tape 2.

The housing 1 includes a first casing 3 and a second casing 31 combined with each other.

The measuring tape assembly further comprises a first level 7, a second level 8, and a magnetic body 10 each mounted on the housing 1. Preferably, the first level 7 is vertical to the second level 8. The housing 1 has a top face formed with a first hole 4 to receive the first level 7, a second hole 5 to receive the second level 8, and an oblique hole 6 to receive the magnetic body 10. The first hole 4 is in parallel with the top face of the housing 1. The second hole 5 is in vertical to the top face of the housing 1. The oblique hole 6 is in vertical to the top face of the housing 1, and has an inclined angle which is ranged from 3 to 5 degrees. The measuring tape assembly further comprises a stop block 9 received in the oblique hole 6 and rested on the magnetic body 10.

The housing 1 has a first end formed with an elongated slot 11, a passage hole 12, and an outlet hole 19. The measuring tape assembly further comprises a locking switch 13 pivotally mounted in the elongated slot 11 of the housing 1 to stop and position the scrolling tape 2. The measuring tape assembly further comprises an illumination device 132 mounted in the passage hole 12 of the housing 1 and provided with an electric wire 131.

The housing 1 has a second end formed with a locking slot 14 and a through hole 15. The measuring tape assembly further comprises a control switch 16 movably mounted in the locking slot 14 of the housing 1 and electrically connected to the electric wire 131 of the illumination device 132. The measuring tape assembly further comprises a laser head 20 mounted in the housing 1 and electrically connected to the control switch 16. The laser head 20 has a distal end provided with a spectroscope 21 mounted in the through hole 15 of the housing 1. Thus, when the control switch 16 is opened, the laser head 20 produces a laser light which passes through the spectroscope 21 and is emitted outward from the through hole 15 of the housing 1, thereby forming a horizontal positioning line via the spectroscope 21.

As shown in FIGS. 4 and 4A, the second end of the housing 1 is formed with two spaced guide tracks 17. The measuring tape assembly further comprises a slide cover 18 slidably mounted between the two spaced guide tracks 17 to open or close the through hole 15. The through hole 15 of the housing 1 is located between the two spaced guide tracks 17.

The scrolling tape 2 is rotatably mounted in the housing 1 and has a distal end extended outward from the outlet hole 19 of the housing 1. The measuring tape assembly further comprises an arcuate guide plate 22 mounted in the housing 1 and encompassing the scrolling tape 2 so as to guide rotation of the scrolling tape 2. In addition, the electric wire 131 of the illumination device 132 is supported on the guide plate 22.

The housing 1 is formed with a receiving portion 23. The measuring tape assembly further comprises a battery 25 mounted in the receiving portion 23 of the housing 1, and a cap 24 mounted on a bottom of the receiving portion 23 of the housing 1 to support the battery 25.

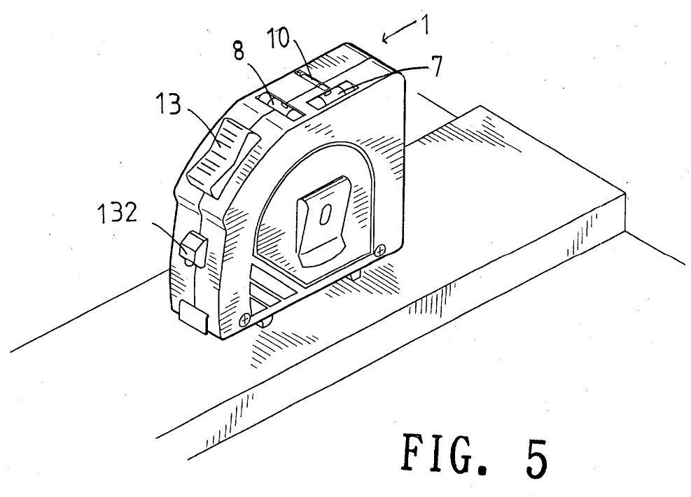

As shown in FIG. 5, the measuring tape assembly is placed on an article. Then, the article is adjusted until the first level 7 and the second level 8 on the housing 1 are disposed at a balanced state. Thus, the measuring tape assembly can be used to adjust and calibrate the level of the article in two directions.

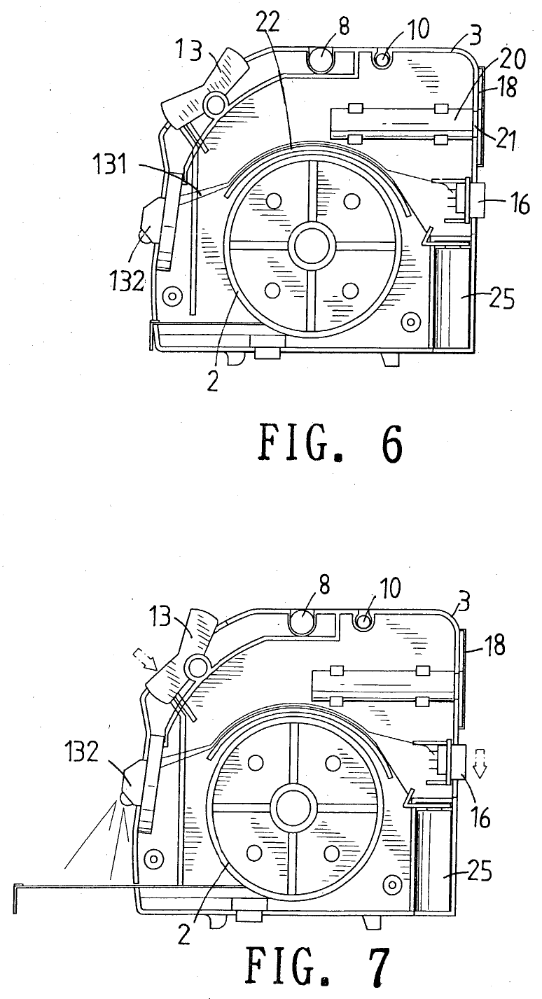

As shown in FIGS. 6 and 7, the control switch 16 is pushed downward to turn on the illumination device 132 which produces a light toward the scrolling tape 2, thereby providing an illumination effect to the user.

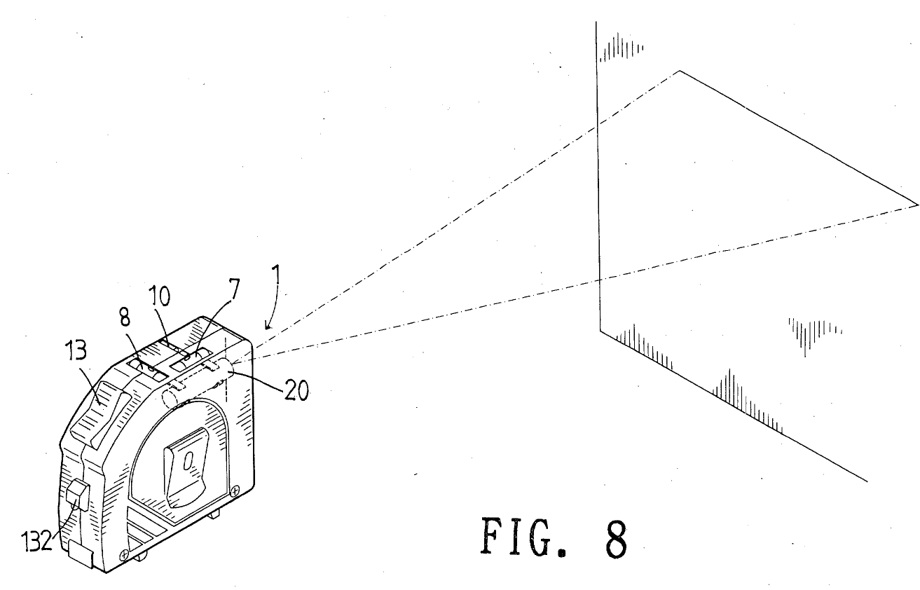

As shown in FIG. 8, the slide cover 18 is moved between the two spaced guide tracks 17 to expose the through hole 15 of the housing 1. Then, the control switch 16 is pushed to trigger the laser head 20 to produce a laser light which passes through the spectroscope 21 and is emitted outward from the through hole 15 of the housing 1, thereby forming a horizontal positioning line via the spectroscope 21, so as to form a horizontal basis for hitting the nail, thereby facilitating the user's work.

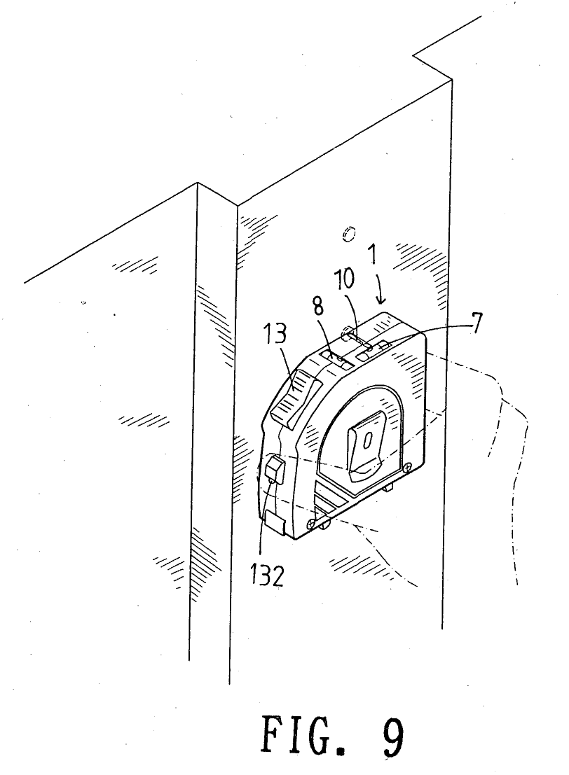

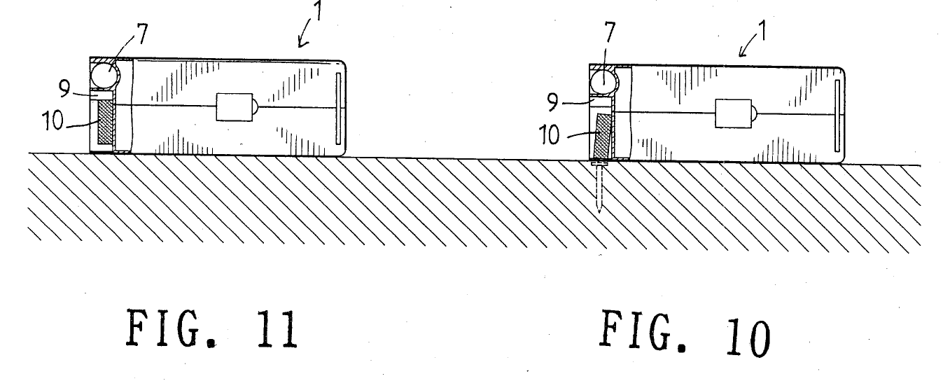

As shown in FIGS. 9 and 10, the measuring tape assembly is rested on the wall to search for the metallic nail. When the magnetic body 10 aligns with the metallic nail, the magnetic body 10 can attract the metallic nail by its magnetic force, so as to identify the position of the joist (or post) by locating the metallic nail nailed in the wall, so that the user can quickly search for the joist (or post) that can be nailed.

As shown in FIG. 11, the oblique hole 6 of the housing 1 has an inclined angle which is ranged from 3 to 5 degrees, so that the magnetic body 10 mounted in the oblique hole 6 of the housing 1 will slide into the inner side of the oblique hole 6 of the housing 1 when not in use.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A measuring tape assembly, comprising:
a housing;
a first level mounted on the housing;
a second level mounted on the housing and having a direction different from that of the first level; and
a scrolling tape rotatably mounted in the housing.

2. The measuring tape assembly in accordance with claim 1, wherein the housing includes a first casing and a second casing combined with each other.

3. The measuring tape assembly in accordance with claim 1, wherein the first level is vertical to the second level.

4. The measuring tape assembly in accordance with claim 1, wherein the housing has a top face formed with a first hole to receive the first level.

5. The measuring tape assembly in accordance with claim 1, wherein the housing has a top face formed with a second hole to receive the second level.

6. The measuring tape assembly in accordance with claim 1, further comprising a magnetic body mounted on the housing.

7. The measuring tape assembly in accordance with claim 6, wherein the housing has a top face formed with an oblique hole to receive the magnetic body.

8. The measuring tape assembly in accordance with claim 7, wherein the oblique hole is in vertical to the top face of the housing and has an inclined angle ranged from 3 to 5 degrees.

9. The measuring tape assembly in accordance with claim 1, further comprising a stop block received in the oblique hole and rested on the magnetic body.

10. The measuring tape assembly in accordance with claim 1, wherein the housing has a first end formed with an elongated slot, and the measuring tape assembly further comprises a locking switch pivotally mounted in the elongated slot of the housing to stop and position the scrolling tape.

11. The measuring tape assembly in accordance with claim 1, wherein the housing has a first end formed with a passage hole, and the measuring tape assembly further comprises an illumination device mounted in the passage hole of the housing and provided with an electric wire.

12. The measuring tape assembly in accordance with claim 1, wherein the housing has a first end formed with an outlet hole, and the scrolling tape has a distal end extended outward from the outlet hole of the housing.

13. The measuring tape assembly in accordance with claim 1, wherein the housing has a second end formed with a locking slot, and the measuring tape assembly further comprises a control switch movably mounted in the locking slot of the housing and electrically connected to an illumination device.

14. The measuring tape assembly in accordance with claim 13, further comprising a laser head mounted in the housing and electrically connected to the control switch.

15. The measuring tape assembly in accordance with claim 14, wherein the housing has a second end formed with a through hole, and the laser head has a distal end provided with a spectroscope mounted in the through hole of the housing.

16. The measuring tape assembly in accordance with claim 15, wherein the second end of the housing is formed with two spaced guide tracks, and the measuring tape assembly further comprises a slide cover slidably mounted between the two spaced guide tracks to open or close the through hole.

17. The measuring tape assembly in accordance with claim 16, wherein the through hole of the housing is located between the two spaced guide tracks.

18. The measuring tape assembly in accordance with claim 1, further comprising an arcuate guide plate mounted in the housing and encompassing the scrolling tape so as to guide rotation of the scrolling tape.

19. The measuring tape assembly in accordance with claim 18, further comprising an illumination device mounted in the passage hole of the housing and provided with an electric wire supported on the guide plate.

20. The measuring tape assembly in accordance with claim 1, wherein the housing is formed with a receiving portion, and the measuring tape assembly further comprises a battery mounted in the receiving portion of the housing, and a cap mounted on a bottom of the receiving portion of the housing to support the battery.
